(19) United States
(12) Patent Application Publication
(10) Pub. No.: US 2026/0205283 A1
(43) Pub. Date: Jul. 16, 2026

(54) Time-Limited Key Derivation

(71) Applicant: Google LLC, Mountain View, CA (US)

(72) Inventors: Janis Danisevskis, Sunnyvale, CA (US); Paul Dermot Crowley, Mountain View, CA (US)

(73) Assignee: Google LLC, Mountain View, CA (US)

(21) Appl. No.: 18/866,949

(22) PCT Filed: May 25, 2022
(86) PCT No.: PCT/US2022/072555

§ 371 Date: Nov. 18, 2024

(51) Int. Cl. H04L 9/08

(52) U.S. Cl. CPC H04L 9/0869; H04L 9/0894

(57) ABSTRACT

Methods, systems, and apparatus, including computer programs encoded on computer-storage media, for time-limited key derivation. In some implementations, a module receives a request that provides a key identifier and obtain a control value indicating a future time. The module obtains a counter value indicating a first time, where the counter value is based on a current state of a counter, and where the counter is configured to update the state of the counter at a predetermined frequency. The module generates a comparison result based on comparing the control value indicating the future time with the counter value indicating the first time. The module generates a key based on the key identifier, the control value, the comparison result, and a stored random number, and the module provides the key in response to the request.

### BACKGROUND

Keys for cryptography can be generated using hardware-based or software-based engines. Keys can include alphanumeric symbols or bits that, when applied to data with an appropriate function, encrypt or decrypt data. Encrypted data can be unrecognizable compared to original non-encrypted data. Encrypted data can be decrypted with a decryption key. Encryption and decryption can use the same key, as in symmetric-key cryptography, or different keys, as in public-key private-key cryptography.

### SUMMARY

In some implementations, a computer system includes a security module that is configured to generate cryptographic keys and enforce time limits for the keys. After a key is generated, the security module allows the keys to be obtained again, but applies time constraints that limit when the keys can be obtained again. The security module can allow many different keys to be generated and can enforce different, customized time limits for the respective keys. The security module can be configured so that, while the time limit for a key is met, the security module can repeatedly generate and provide the same key. However, when the time limit is not met (e.g., after an expiration time for a key is reached), the original key cannot be obtained. For example, if the time limit is not satisfied, an attempt to obtain the key from the security module will result in a new key that does not match the original key.

The security module can be used to generate keys and enforce time constraints on obtaining the keys without storing the keys or the corresponding time constraints. This enables the security module to generate very large numbers of unique keys with only a minimal amount of state information being stored in the security module. This is a significant advantage because the security module does not need to include memory for key storage and also does not need to track generated keys and their corresponding time constraints. Rather than storing generated keys, the security module can be configured to generate each key anew when the key is requested. Providing the same set of input results in generation of the same key as long as the time constraint is satisfied.

When generating a key, the security module provides a set of input, e.g., a key derivation context, as input to a key derivation function. This set of input includes an identifier for the key and a value representing the time limit for the key. The security module also determines whether the time limit has been reached and includes the result in the set of input. For example, the security module compares a counter value from an internal counter with a received control value representing the time limit for the key, and the comparison result is included in the set of input provided to the key derivation function. Because the key derivation process uses the comparison result as an input, a change in the comparison result (e.g., due to passing an expiration time for the key) will produce a different key than was originally obtained. As a result, once an expiration time is reached, the security module effectively “forgets” the original key and the original key cannot be generated by or obtained from the security module again.

The security module can apply various types of time constraints to the generation of keys. As an example, the time constraint for a key can set an expiration time, so that the key can be generated again until the expiration time is reached but not afterward. As another example, the time constraint for a key can block generation of the key until a predetermined time, but allow the key to be generated afterward. This mode can provide “time vault” or time lock functionality where access is gained only once the predetermined time is reached.

The security module can be configured to provide keys in response to requests from an operating system, applications, software or hardware modules, or another requesting party. A request for a key can includes key identifier that identifies the key. The request can also include a control value that indicates an expiration time after which the key can no longer be generated again or access time before which the key cannot be generated again. The security module can process the key identifier and the control value, including comparing the control value with a counter value from a counter of the security module, to generate a set of input data that uniquely identifies the key to be generated. The security module can then use the set of input data to generate the requested key. The security module can provide the key to the requester be used for subsequent cryptographic operations, such as encryption or decryption.

The security module can provide the ability to limit the range of time in which keys can be obtained, and can do so with greater efficiency and security than other approaches. For example, some traditional key derivation methods use a key store that stores a number of active or inactive keys. The key store requires storage resources sufficient to store all required keys. In contrast, the processes described herein allow a device to maintain a set of active or inactive keys which are limited by time without storing the keys. Instead, entities requesting the keys store key identifiers and control values that represent time limits. Because keys are generated by identification information and control values provided by requesting parties, the security module generating the keys need not store any keys or access a storage component that stores keys. In this way, the number of keys in circulation is not limited by storage requirements. Security is also improved because there are no stored keys that could potentially be accessed without authorization by an attacker.

To obtain a key, an entity, such as a requesting party, can provide an identifier and a control value. The security module can perform operations based on the identifier and control value, as discussed further below, to generate a corresponding key. The security module can be configured to operate in various different modes to generate keys with different types of time constraints. For example, keys generated in one mode can have an expiration time set, so the key can be generated before the expiration time but the security module “forgets” the key after the expiration time and the key becomes unrecoverable. As another example, key can be generated using a mode in which, after the key is initially generated, the key cannot be generated again until a predetermined future access time. In effect, the key is secured in a time-locked “vault”, and after the access time occurs the “vault” is open and the key can be generated again. The time for access or expiration can be defined by the control value used.

The techniques described herein can be used to provide strong, time-based protection for access control information. Many systems use keys that are bound to a lock screen knowledge factor. For example, some cryptographic keys can be generated only after the user presents lock screen knowledge factor (LSKF), such as a personal identification number (PIN), pattern, or password. However, enforcing time limits on authorization is often done using software policies or properties that may be vulnerable to be circumvention or attack. To provide stronger enforcement of time limits for access control, keys and authorization tokens bound to the LSKF can be cached after the access tokens are first encrypted using a time-limited key, e.g., a key generated using the time-limited derivation processes discussed herein. Because the key generation is subject to a time constraint, after reaching the expiration time (e.g., a predetermined time such as one hour after entry of the LKSF) the key can no longer be generated again. This can enforce the desired authorization time limit and force re-entry of the LKSF to authorize new access after the expiration time. After the expiration time, applications will be unable to obtain the time-limited key, and so any applications that have not obtained the time-limited key before the expiration time will be unable to decrypt and use the encrypted authorization token from the cache.

An innovative aspect of the subject matter described in this specification is embodied in a method that includes receiving a request that provides a key identifier; obtaining a control value indicating a future time; obtaining a counter value indicating a first time, where the counter value is based on a current state of a counter, where the counter is configured to update the state of the counter at a predetermined frequency; generating a comparison result based on comparing the control value indicating the future time with the counter value indicating the first time; generating a key based on the key identifier, the control value, the comparison result, and a stored random number; and providing the key in response to the request.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, at least obtaining the counter value, generating the comparison result, and generating the key are performed by a secure hardware module.

In some implementations, at least obtaining the counter value, generating the comparison result, and generating the key are performed by a secure hardware module of a system-on-a-chip of a mobile device.

In some implementations, before receiving the timestamp, actions include providing (i) a counter value from the hardware-based counter and (ii) the counter value frequency.

In some implementations, the stored random number is generated by a hardware-based random number generator.

In some implementations, actions include detecting a manipulation of the counter; and in response to detecting the manipulation of the counter, replacing the stored random number with a new random number obtained from the hardware-based random number generator.

In some implementations, actions include detecting an overflow of the counter; and in response to detecting the overflow of the counter, replacing the stored random number with a new random number obtained from the hardware-based random number generator.

In some implementations, the predetermined frequency is based on a frequency of a clock signal; and actions include detecting a change in the frequency of the clock signal; and in response to detecting the change in the frequency of the clock signal, replacing the stored random number with a new random number obtained from the hardware-based random number generator.

In some implementations, after generating the key, and before providing the key in response to the request, actions include obtaining a second counter value from the counter based on a state of the counter after the key is generated; determining that the second counter value satisfies a predetermined condition specifying a relationship with respect to the control value; and where providing the key in response to the request is performed in response to determining that the second counter value satisfies the predetermined condition.

In some implementations, determining that the second counter value satisfies the predetermined condition includes determining that the second counter value represents a time that is before the future time represented by the control value.

In some implementations, the control value is a future counter value representing a value that the counter will reach at the future time.

In some implementations, the control value specifies a counter value that, when reached by the counter, disallows further generation of the key based on the key identifier and the control value.

In some implementations, actions include operating a secure hardware module configured to (i) enable the key to be generated again before the future time in response to receiving the control value and key identifier and (ii) disallow generation of the key after the future time.

In some implementations, the counter value is a first counter value and the key is a first key; the secure hardware module is configured to disallow generation of the first key after the future time by providing, in response to receiving the control value and key identifier, a second key that is different from the first key; and the second key is generated to be different from the first key based on a comparison result of comparing a second counter value with the control value being different from the comparison result of comparing the first counter value with the control value.

In some implementations, the key is a first key, and the comparison result is a first comparison result; and actions include, after generating the first key receiving a second request associated with the key identifier and the control value; obtaining a second counter value based on a state of the counter, the second counter value indicating a second time that is after the first time and before the future time indicated by the control value; generating a second comparison result based on comparing the control value indicating the future time with the second counter value indicating the second time, where the second comparison result is the same as the first comparison result; and generating a second key based on the key identifier, the control value, the second comparison result, and the stored random number, where the second key is the same as the first key.

In some implementations, the key is a first key, and the comparison result is a first comparison result; and actions include, after generating the first key receiving a second request associated with the key identifier and the control value; obtaining a second counter value based on a state of the counter, the second counter value indicating a second time that is after the future time indicated by the control value; generating a second comparison result based on comparing the control value indicating the future time with the second counter value indicating the second time, where the second comparison result is different from the first comparison result; and generating a second key based on the key identifier, the control value, the second comparison result, and the stored random number, where the second key is different from the first key.

In some implementations, obtaining the control value includes receiving a time value indicating the future time or an amount of time until the future time is reached; and determining, as the control value, a future counter value that will be reached at the future time, the future counter value being determined based on a current counter value from the counter, the time value, and the predetermined frequency.

In some implementations, actions include, after providing the key, disallowing further generation of the key until the future time is reached.

In some implementations, actions include determining a vault context value based on the comparison result, where the comparison result is used to select the vault context value from among a vault counter value and an input vault context value; and generating the key involves applying a key derivation function to a set of values include the key identifier, the control value, the comparison result, the stored random number, and the vault context value.

In some implementations, actions include providing the vault context value. In some implementations, actions include obtaining a mode selection value configured to select from among multiple modes for generating keys, the multiple modes including (i) a first mode that disallows further generation of the key after the future time and (ii) a second mode that disallows further generation of the key before the future time; and generating the key involves applying a key derivation function to a set of values including the key identifier, the control value, the comparison result, the stored random number, and the mode selection value.

An innovative aspect of the subject matter described in this specification is embodied in a hardware module for generating cryptographic keys that includes an input interface configured to receive (i) a control value representing a time and (ii) a key identifier; a random number generator and a memory element that is configured to store a random number generated by the random number generator; a counter configured to change monotonically based on a clock signal; a comparator configured to generate a comparison result based on a comparison of the control value with a counter value from the counter; and key derivation circuitry configured to generate a key based on the key identifier, the control value, the comparison result, and a random number stored in the memory element.

In some implementations, the hardware module enables the key to be generated again before the future time in response to receiving the control value and the key identifier, and the hardware module disallows generation of the key after the time represented by the control value.

In some implementations, the hardware module limits a time period in which the key can be generated again, and the control value represents a future counter value that set a future time at which the time period expires.

In some implementations, the hardware module limits a time period in which the key can be generated again, and the control value represents a future counter value that sets a future time at which the time period begins.

In some implementations, the hardware module is configured to determine whether the counter value from the counter has a predetermined relationship with respect to the control value; and the hardware module is configured to selectively output the key depending on whether the counter value from the counter has the predetermined relationship with respect to the control value.

In some implementations, the hardware module is configured to determine a second counter value based on a state of the counter after the key is generated and to determine whether the second counter value has a predetermined relationship with respect to the control value; and the hardware module is configured to (i) output the key if the second counter value has the predetermined relationship with respect to the control value and (ii) block output of the key if the second counter value does not have the predetermined relationship with respect to the control value.

In some implementations, the hardware module is configured to detect alteration of the clock signal and to replace the random number stored in the memory element with a new random number from the random number generator in response to detecting alteration of the clock signal.

In some implementations, the hardware module is configured to detect overflow of the counter and to replace the random number stored in the memory element with a new random number from the random number generator in response to detecting overflow of the counter.

In some implementations, the hardware module is configured to output counter values from the counter.

In some implementations, the hardware module is enabled to generate multiple different keys and enforce separately-specified expiration times for the ability to re-generate the respective keys, without storing the keys and without storing the expiration times.

In some implementations, the input interface is configured to receive an input context value; the hardware module is configured to determine a context value based on the comparison result, where the comparison result is used to select the context value from among (i) a counter value from a second counter and (i) the input context value; and the key derivation circuitry is configured to apply the key derivation function to a set of values including the key identifier, the control value, the comparison result, the stored random number, and the determined context value.

In some implementations, the hardware module is configured to provide the determined context value as an output of the hardware module.

In some implementations, the input interface is configured to receive a mode selection value that identifies a mode selected from among multiple modes for generating keys, the multiple modes including (i) a first mode that disallows further generation of the key after the future time and (ii) a second mode that disallows further generation of the key before the future time; and the key derivation circuitry is configured to apply the key derivation function to a set of values including the key identifier, the control value, the comparison result, the stored random number, and the mode selection value.

In some implementations, the hardware module is configured to perform an operation on the mode selection value and the comparison result, and the key derivation circuitry uses a result of the operation when generating the key.

In some implementations, the operation is an exclusive OR operation.

In some implementations, the hardware module includes a multiplexer configured to select from among multiple input values to provide a context value to the key derivation circuitry; the multiple input values include a predetermined value, an input context value, and a counter value from a second counter; the multiplexer is configured to select the context value from among the multiple input values based on the mode selection value and the comparison result; and the context value selected by the multiplexer is included in the set of values to which the key derivation circuitry applies the key derivation function to generate the key.

In some implementations, the hardware module includes a second counter that is configured to alter its stored value in response to the generated key being read from the secure hardware module; the hardware module is configured to use counter values from the second counter in generation of keys such that, after the generated key is read from the hardware module, the hardware module blocks further generation of the key until the time represented by the control value is reached.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for time-limited key derivation.

FIG. 2A is a diagram showing an example of a security module that can be used to perform time-limited key derivation.

FIG. 2B is a diagram showing a second example of a security module that can be used to perform time-limited key derivation.

FIG. 2C is a diagram showing an example of an iterative key engine used to perform time-limited key derivation.

FIG. 3 is diagram showing a third example of a security module that can be used to perform time-limited key derivation.

Like reference numbers and designations in the various drawings indicate like elements.

### DETAILED DESCRIPTION

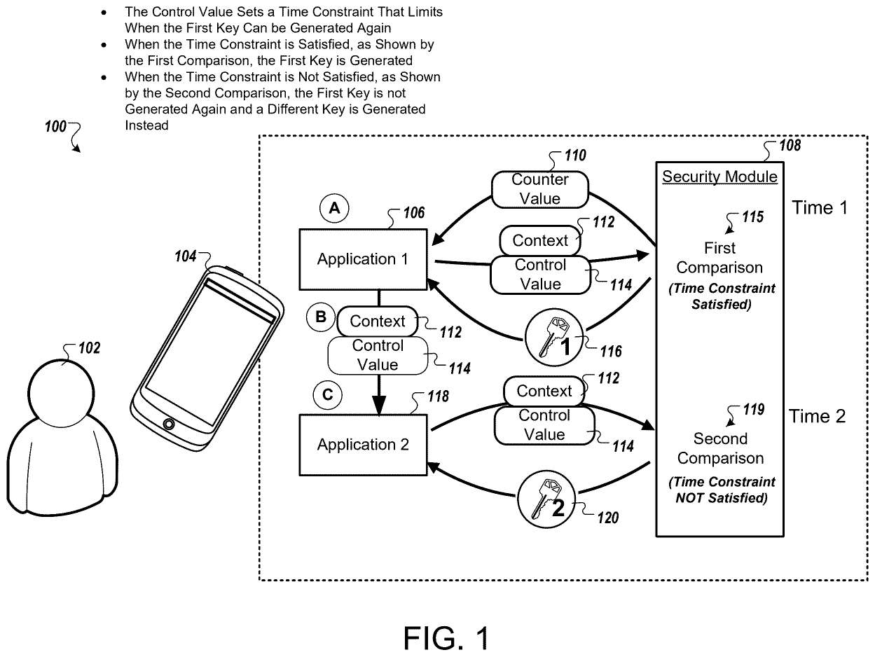

FIG. 1 is a diagram showing an example of a system 100 for time-limited key derivation. The system 100 includes a device 104 operated by user 102. The device 104 can be a computing device such as a laptop computer, a desktop computer, a server computer, a tablet computer, a smartphone, a smartwatch, a smart speaker, a navigation device, a television, an appliance, an entertainment device, etc. The device 104 includes a security module 108 that is configured to generate cryptographic keys and to place limits on the ranges of time in which the keys can be obtained. The security module 108 can be implemented as a module of an integrated circuit, such as a system on a chip (SoC), central processing unit, chipset, or trusted platform module. In some implementations, the security module 108 operates within a trusted execution environment (TEE) of the device 104.

FIG. 1 shows a series of operations and data flows labeled as stages (A)-(C). Briefly, two software modules running on the device 104, a first application 106 and a second application 118, each interact with the security module 108 to obtain a key from the security module 108. The first application 106 requests the key before a predetermined expiration time and so receives the desired key 116. By contrast, the second application 118 requests the key after the predetermined expiration time and receives a different key 120 as a result. This demonstrates how the security module 108 enforces the time limit on generation of the key, so that the original key 116 can no longer be obtained from the security module 108 after the expiration time.

In stage (A), the first application 106 interacts with the security module 108 to obtain a key 116. To request a key in this example, applications provide two items: (1) a context, which serves as an identifier for the key to be generated, and (2) a control value, which specifies a time (e.g., an expiration time) for a time limit on generation of the key. The security module 108 uses these two items, along with other data, to generate keys.

To enforce time limits, the security module 108 includes a monotonic counter that is regularly updated based on a clock signal. The control value can specify an expiration time as a value that the counter will reach at the desired expiration time. To enable applications to determine control values and set custom expiration times for keys, the security module 108 is configured to provide the current counter value as an output. Here, the security module 108 provides a counter value 110 that indicates the current value of the counter. In some implementations, the security module 108 provides the counter value 110 in response to a request from the first application 106 for the counter value 110. In other implementations, the security module 108 can make the counter value 110 available in a register, memory, or other element so that the first application 106 or another element can simply read the current value of the counter.

The application 106 generates and sends a request for a key that includes a context 112 and a control value 114. The context 112 is a key identifier that identifies the key to be generated. The context 112 can indicate the purpose of the key or the type of key being generated, and serves to distinguish the key from others that might have the same expiration time. The context 112 can be expressed as text, numbers, or in any other appropriate form.

The application 106 determines the control value 114 to set a desired expiration time after which the key can no longer be generated. The expiration time can be specified as a future value of the counter in the security module, e.g., as the counter value that will occur at the desired expiration time. For example, the application 106 can use the current counter value 110 from the security module and add an offset to it to obtain the control value 114. The value of the offset is determined based on the desired expiration time and the rate at which the counter is incremented. For example, if the counter is incremented every clock cycle, the offset can be determined by multiplying the clock frequency (e.g., cycles per second) with the number of seconds in the future that expiration should occur.

For example, to compute the control value 114, the first application 106 can determine an amount of time between a current time and a desired future expiration time. The first application 106 can determine, based on a clock frequency of a clock generating the counter value 110, a number of clock cycles, and thus counter increments, that will occur from current time until the expiration time. For example, if an expiration time is 1 hour in the future and the counter updates at a rate of once per second, the control value 114 can be determined by adding together the current counter value 110 and the number of increments that occur in 1 hour (e.g., 3600, for 3600 seconds times a counter update frequency of 1 Hz).

The security module 108 receives the first application's request for a key at a first time, labeled “Time 1” in the figure. The security module 108 obtains the context 112 and the control value 114 from the request. As part of generating the requested key, the security module 108 performs a comparison between the received control value 114 and the current state of the counter within the security module 108. This is represented as first comparison 115 and the result indicates whether the expiration time represented by the control value 114 has been reached or not. For example, the comparison result can be “0” to indicate that the current counter value is still less than the control value 114. The security module 108 uses the control value 114 and the comparison result in the set of input that the security module 108 provides to a key derivation function to generate the requested key, which in this case is key 116. Including the comparison result in the set of input for key derivation ensures that the key 116 can only be generated before the expiration time. After the expiration time, the comparison result will be different (e.g., “1” instead of “0”), resulting in a key different from the key 116.

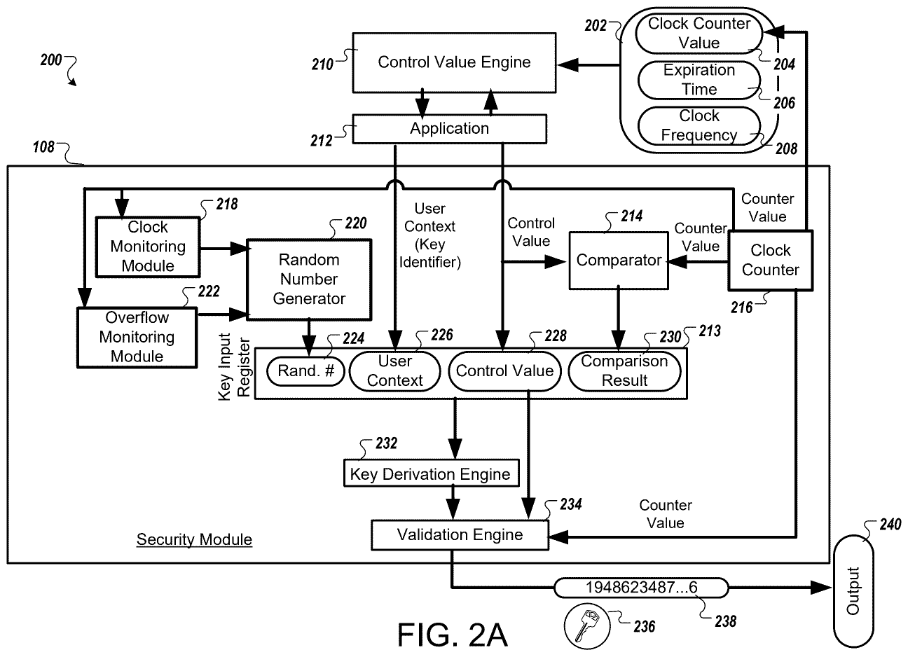

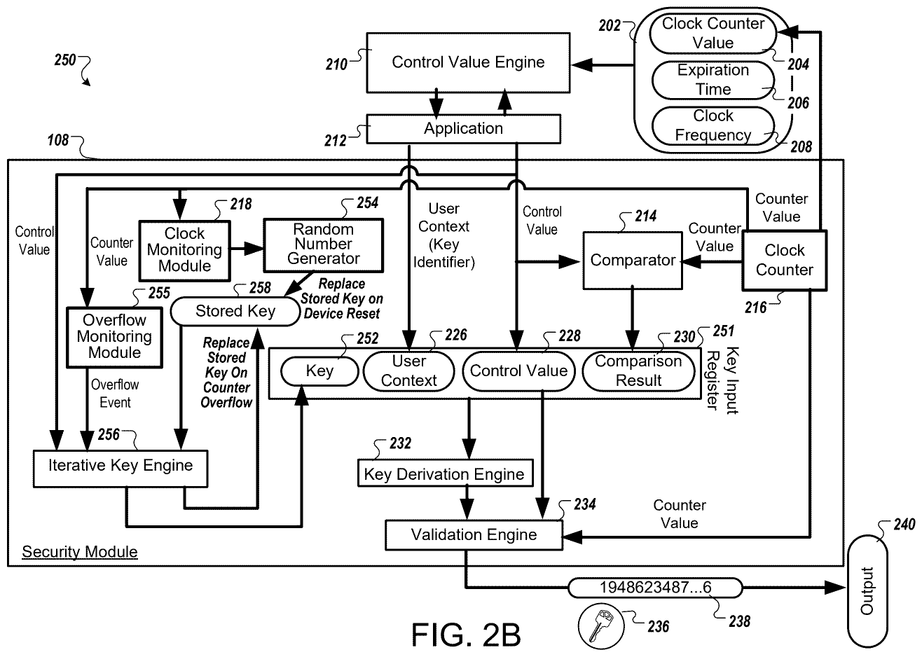

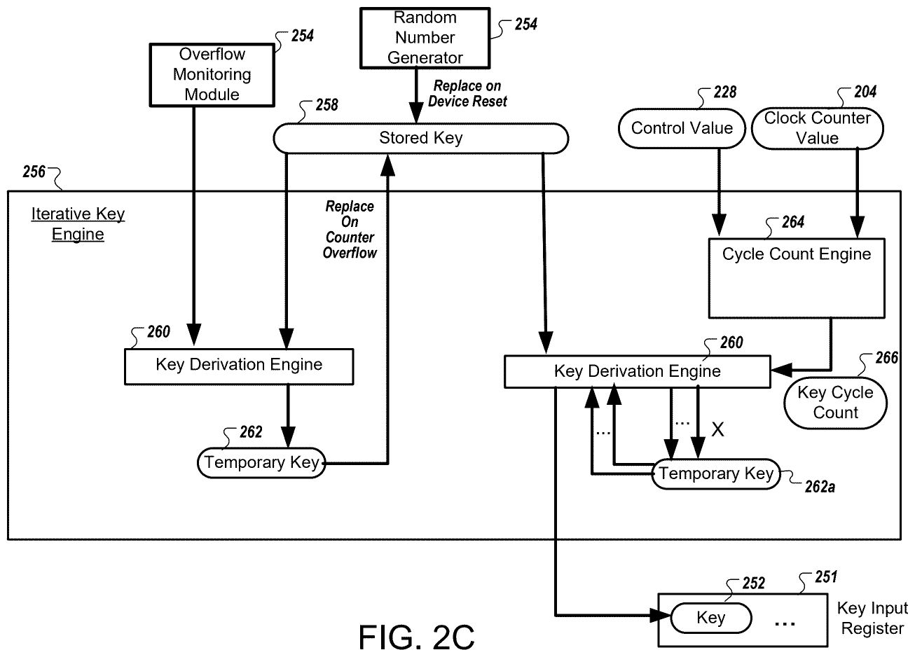

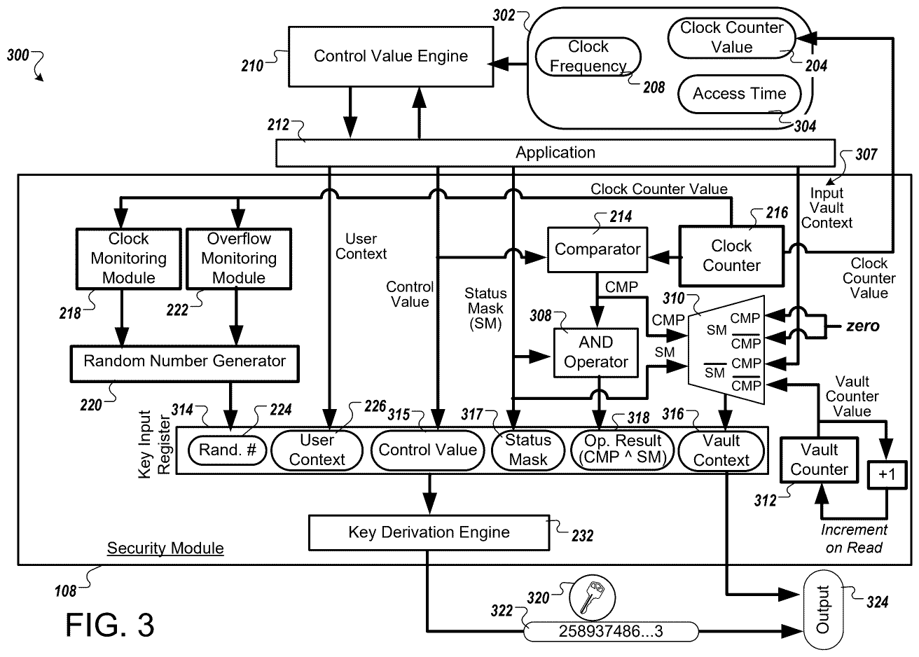

In the example of FIG. 1, the security module 108 provides the first key 116 in response to obtaining the context 112 and the control value 114. Details regarding the process of generating keys are discussed further below with respect to the following figures, including FIGS. 2-3.

In some implementations, the first key 116 is a cryptographic key that may be used to encrypt or decrypt data. For example, the user 102 or the application 106 can cause the first key 116 to encrypt data before sending the encrypted data to data storage, a process or module of the device 104, or another device. In order for another module to be able to obtain the first key 116 and decrypt the data, the context 112 and the control value 114 can be provided to the other module so it too can request and obtain the first key 116 from the security module 108. In some implementations, the context 112 and the control value 114 are sent in an encrypted form, having been encrypted using another encryption key that is known to the other module. For example, a module can decrypt data that includes the context 112 and the control value 114, and then provide the context 112 and the control value 114 to the security module 108 to obtain a key to decrypt the data encrypted with the first key 116.

In stage (B), the first application 106 information to the second application 118 that enables the second application 118 to obtain the first key 116 from the security module 108, subject to the time constraint on generating the first key 116. As illustrated, the first application 106 provides the context 112 and the control value 114 to the second application 118. In some implementations, the first application 106 provides the context 112 and the control value 114 to the second application 118 in addition to other data which may be encrypted with the first key 116. In some implementations, a data package sent from the first application 106 to the second application 118 includes the context 112 and the control value 114, encrypted using an encryption key that is different from the first key 116. In this case, the second application 118 can decrypt the data package that includes the context 112 and the control value 114 and use these values to request the first key 116 from the security module 108.

In stage (C), the second application 118 attempts to obtain the first key 116 from the security module 108. However, because the time limit on generation of the first key 116 has been reached, the security module 108 no longer permits the first key 116 to be generated. The second application 118 sends a request to the security module 108 at a second time, labeled “Time 2.” In the example, this time is after Time 1 and is also after the expiration time that is specified by the control value 114. The request sent by the second application 118 provides the same context 112 and the same control value 114 that the first application 106 used when originally obtaining the first key 116 to the security module 108. If the second time had been before the expiration time, as it was when the first key 116 was originally generated, then the security module 108 would have generated the same first key 116 that was provided to the first application 106. However, because the second time is after the expiration time, the set of values used to generate the key is different and so the security module 108 generates a second key 120 that is different from the first key 116.

As part of responding to the request from the second application 118, the security module 108 performs a second comparison 119, to determine whether the current time is before the expiration time for the key. For example, the security module 108 obtains a current counter value indicating the value of the internal counter. The security module 108 compares the current clock value with the control value 114. The comparison result, e.g., “1,” indicates that the counter value is greater than the control value 114, and thus that the current time is after the expiration time. Due to the timing, the result of comparison 119 (“1”) is different from the result of the earlier comparison 115 (“0”). The result of comparison 119 is included in the set of input used to generate a key in response to the request from the second application 118, and so the security module generates key 120 which is different from key 116, even though both keys 116, 120 were generated based on the same context 112 and control value 114. By generating a different key 120 after the time limit expires, the security module 108 ensures that the time limit on generation of the first key 116 is enforced.

The discussion of FIG. 1 above describes setting an expiration time for the ability to generate the first key 116, but other types of time constraints may be set. For example, the security module 108 can operate in a time vault mode where the first key 116 can be generated once but cannot be generated again until a certain time, e.g., an access time, has passed. In this case, the first key 116 can represent the initial key generated, and the second key 120 can represent a key requested before the predetermined access time. Thus, in the time vault mode, the security module 108 can block requesting modules from obtaining the key until the access time, and after the access time the first key 116 becomes available.

In some implementations, operations described as performed by the first application 106 or the second application 118 are performed by another process or component of the device 104. For example, requests to obtain keys can be provided by an operating system, a software module that is not an application, a hardware module on the same integrated circuit as the security module 108 or a different integrated circuit, and so on.

FIG. 2A is a diagram showing an example of a system 200 for generating a key with an expiration time. The system 200 includes the security module 108 and shows the operation of the security module 108 in the device 104 and its interactions with applications or other modules in further detail. The security module 108 can be implemented as part of a system on a chip (SoC) or another integrated circuit of the device 104. The security module 108 includes a comparator 214, a clock counter 216, a clock monitoring module 218, a random number generator 220, an overflow monitoring module 222, a key input register 213, a key derivation engine 232, and validation engine 234. The system 200 also includes a control value engine 210 and an application 212.

In some implementations, the security module 108 is a hardware element of a computer or other electronic device. For example, the security module 108 can be implemented using one or more integrated circuits. The security module 108 can be implemented in secure hardware that is tamper-resistant to avoid external interference with the key generation process.

The example of FIG. 2A shows the security module 108 generating a key with a custom time constraint on the range of time the key can be obtained. As an overview, the security module 108 obtains data from an entity, such as the application 212, to generate the values in the key input register 213. The security module 108 then sends the data in the key input register 213 to the key derivation engine 232, which applies a key derivation function to that data to generate a key 236. In some implementations, the key 236 is represented by one or more alphanumeric symbols as shown in item 238. The key derivation engine 232 provides the key 236 as output 240, for example, in response to the request from the application 212 to generate the key. In general, the system 200 can generate and provide keys to any entity, including processes or devices.

The security module 108 is configured to generate keys based on the values in the key input register 213. Changing any of the values in the key input register 213 changes the resulting key that will be generated. In the example of FIG. 2A, two of the values (the user context 226 and the control value 228) are provided from outside the security module by the application 212 that is requesting a key. Two other values (a random number 224 and a comparison result 230) are generated within the security module 108 and cannot be altered by external modules. The contents of the key input register 213, taken together, form the overall key derivation function (KDF) context that is the source data or seed data that the key derivation engine 232 uses to generate a key. The security module 108 can be configured to use the same key derivation function consistently over time, so that when the same KDF context is provided repeatedly, the same key is generated.

The security module 108 includes an entropy source in the form of a random number generator 220. The random number generator 220 produces a random number 224 that is stored in the key input register 213. The random number 224 is not replaced with each key request, and instead is maintained over time and is re-used for many key requests, unless certain conditions occur to change the random number stored. Because the random number 224 is part of the KDF context for all keys generated, a change in the stored random number 224 irreversibly makes all previous keys irretrievable. As a result, the value of the stored random number 224 is typically changed or initialized only in response to events that make it desirable to make previous keys irretrievable, such as each power cycle of the device 104, manual reset of the device 104, overflow of the clock counter 216, or a change in the clock signal (e.g., slowdown or stop of the clock signal, which can affect the measurement of time used to enforce time constraints). The random number 224 is an important and sensitive part of the key generation process, and so it is protected against leakage and manipulation, e.g., against glitching and access or manipulation through power or timing side channels.

The security module 108 uses a clock signal to gauge the passage of time and enforce time limits. This clock signal is typically provided by an external source, such as a clock generation module of the SoC or integrated circuit that includes the security module 108. To track the passage of time, the security module 108 uses the clock counter 216 to change state monotonically in response to pulses of the clock signal. For example, the clock counter 216 can be a digital counter configured to increment a stored value at each clock cycle (e.g., for each rising edge of the clock signal). Of course, other variations can be used. For example, the clock counter 216 may be configured to decrement the counter value rather than increment the counter value. As another example, the clock counter 216 may be configured to adjust the stored value after some number of clock cycles has occurred (e.g., every 10 cycles, every 100 cycles, etc.) rather than for every cycle.

Because the security module 108 relies on the clock signal and the clock counter 216 to track the passage of time, the security module 108 can include elements to detect and respond to conditions that interfere with this tracking of time. For example, a clock monitoring module 218 can detect variation in the clock signal (e.g., change in the clock frequency or stopping of the clock) and can trigger the random number generator 220 to replace the stored random number 224 with a new random number in response. Similarly, an overflow monitoring module 222 can detect overflow of the clock counter 216 and can trigger the random number generator 220 to replace the stored random number 224 with a new random number in response. These changes to the stored random number 224 make all previously generated keys irretrievable, to avoid the possibility of any keys being obtained outside the appropriate time limits. The monitoring modules 218, 222 are discussed further below.

To request a key, the application 212 provides a user context 226 and a control value 228 to the security module 108. These two values uniquely identify the key that is desired and enable the security module 108 to generate the desired key, as long as the time constraint for the key is satisfied and the random number 224 does not change. The user context 226 is a key identifier that can specify the key or its purpose. In some implementations, the user context 226 can be an arbitrary value, subject to a size limit, that is chosen by the application that originally requests the key to be created.

The control value 228 specifies a time limit to be applied for the key. In the example of FIG. 2A, the security module 108 is configured so that the control value 228 specifies an expiration time after which the key can no longer be generated. This expiration time can be selected by the application 212 that is requesting the key to be generated. With the control value, the security module 108 allows a separate, custom-defined expiration time to be specified for each key generated by the security module. The first time a key is generated, the control value 228 can be required to be a time in the future, so that the expiration time is not reached before the initial key generation.

The control value 228 can specify the expiration time relative to the state of the clock counter 216 in the security module 108. For example, the control value 228 can be a timestamp representing the expiration time, in particular, a timestamp for a future time after which generation of the key will no longer be permitted. To enable applications or other modules to determine control values, the security module 108 allows counter values to be read outside the security module 108. The current counter value thus serves as the base value or reference from which times in the future are specified. The counter value 204, together with a known clock frequency 208 or counter update frequency, can be used to set the control value 228 to a desired expiration time when requesting a new key.

In some implementations, a control value engine 210 is provided to generate control values representing desired expiration times. For example, the application 212 can provide a desired expiration time 206 to the control value engine 210, and the control value engine 210 can return a control value 228 that represents the expiration time 206. The set of data that the control value engine 210 uses to generate a control value 228 includes the current clock counter value 204 from the clock counter 216, the expiration time 206 specified by the application 212, and a clock frequency 208 indicating the rate that the clock counter 216 is updated. In some implementations, the control value engine 210 obtains the clock frequency 208 from the security module 108. For example, the security module 108 can provide the clock counter value 204 in addition to the clock frequency 208. As discussed above, the clock counter 216 changes monotonically (e.g., consistently increments or consistently decrements) its value based on the clock frequency 208.

Based on the data 202, the control value engine 210 generates the control value 228. The expiration time 216 may be expressed as a specific time (e.g., 1:02 pm, at a desired level of precision) or as an offset (e.g., 1 hour in the future). In some implementations, the control value engine 210 determines a time difference between a current time and the expiration time 206. For example, the control value engine 210 can obtain a current time from a local time service of the device 104. The control value engine 210 can compute a difference between the current time and the expiration time 206. Based on the clock frequency 208, the control value engine 210 can compute the number of increments that will occur over the period of time from the current time to the expiration time 206. The control value engine 210 can add that number of increments to the current clock counter value 204 to generate the control value 228 indicating the future value of the clock counter 216 that will occur at the expiration time 206. The control value engine 210 provides the control value 228 to the application 212.

After the application 212 provides the control value 228 and the user context 226 to the security module 108, the security module 108 populates the contents of the key input register 213. The control value 228 and the user context 226 can be included directly included in the key input register 213. This is not required, however, and in some implementations, the security module 108 may generate a modified version of the user context provided by the application 212. For example, the security module 108 may apply rules to adjust one or more values of the user context provided by the application 212 to generate the user context 226 stored in the key input register 213. The adjustments can include adjustments to conform the user context to a specific format for inclusion in the key input register 213, such as to adjust the data format, truncate the data or add padding values to fit a desired data size, etc. If any adjustments are made, they are done in a repeatable manner so that the same input user context results in the same user context in the key input register 213 each time.

The security module 108 also determines a comparison result 230 to include in the key input register 213. The comparison result 230 indicates whether the current clock counter value exceeds control value. In effect, this checks whether the current time is after the expiration time 206. To perform the comparison, the security module 108 provides the control value 228 and the current counter value to the comparator 214. The comparator 214 implements a Boolean comparison function. For example, the comparator 214 can perform a less than comparison, a less than or equal to comparison, a greater than comparison, or a greater than or equal to comparison. The specific comparison used (e.g., less than vs. greater than) is not important here, as long as the same comparison function is used and the comparison result changes after the expiration time.

The comparator 214 generates a comparison result 230 based on a comparison of the control value 228 and the counter value from the clock counter 216. In some implementations, the comparison result 230 includes one or more bits. For example, the comparison result 230 can be a single bit indicating a comparison result from the comparator 214. For example, a value of “0” can be provided for comparison result before the expiration time, and a value of “1” can be provided as the comparison result after the expiration time. The comparison result 230 completes the set of data in the key input register 213.

The security module 108 provides the set of data in the key input register 213 (e.g., the stored random number 224, the user context 226, the control value 228, and the comparison result 230) as input to the key derivation engine 232. The key derivation engine 232 can be a component of the security module 108.

The key derivation engine 232 generates the key 236. In some implementations, the key derivation engine 232 generates the key 236 based on the Rivest-Shamir-Adleman (RSA) scheme. In some implementations, the key derivation engine 232 generates the key 236 based on one or more secure hash algorithms (SHA), e.g., SHA-224, SHA-256, SHA-384, SHA-512, SHA-512/224, SHA-512/256.

The key derivation engine 232 generates the key 236 based on the set of input in the key input register 213 such that any change to the contents of the key input register 213 will change the resulting key that is generated, but the same contents of key input register 213 will generate the same key 236. That is, if an entity, e.g., the application 212 or another application, process, or device, provides the user context 226 and the control value 228 to the security module 108 and the time conditions of the key generation are satisfied, the entity can obtain the same key 236 that the application 212 obtains.

The security module 108 provides the key 236 as output 240 to the application 212. In general, the security module 108 can be made available for any of various entities to provide context values and control values to obtain keys from the security module 108. As a result, the security module 108 can provide a key generation service for many different hardware modules and software modules to obtain keys, with each key having its own custom-defined expiration time.

In some implementations, the security module 108 includes a validation engine 234 that checks that one or more conditions are satisfied. For example, it is desirable for the security module 108 to ensure that, at least in the first instance that a key is requested, that the time limit for the key has not expired before the key is generated. In particular, it is desirable to ensure that the key is generated with a counter value that is still less than the control value 228, so that the key generation is based on a comparison result 230 that indicates that the expiration time has not yet been reached. Otherwise, if the comparison result 230 used to create the original key shows that the expiration time had already passed, then all future key requests would produce the same key, regardless of how far in the future they occur. In effect, generating a key at a time after the expiration time set by the control value 228 will create a key that will never expire. This behavior would be unexpected and undesirable if an application or module expects that a time limit is being enforced, but in fact no time limit restricts future generation of the key.

To verify that the generated key is validly generated with an expiration time that is still in the future, the validation engine 234 can obtain a counter value from the clock counter 216. For example, the validation engine 234 can obtain a counter value that represents the state of the counter 216 after the key derivation engine 232 has derived the key 236. The validation engine 234 then compares the obtained counter value with the control value 228 to ensure that, even after the key 236 is generated, the current counter value is still less than the control value 228 (e.g., the counter value has not been incremented to the extent that it reaches or exceeds the control value 228). The validation engine 234 may use other techniques to determine that the key 236 was properly generated based on a future expiration time rather than an inappropriate past time. For example, the validation engine 234 may check that the counter value used to generate the comparison result 230 was less than the control value 228 or the validation engine 234 may check the comparison result 230 itself to verify that it shows that the counter had not reached the control value 228.

In some implementations, the validation engine 234 may check one or more other conditions, such as whether a difference between the counter value from the clock counter 216 and the control value 228 satisfies a threshold. For example, the validation engine 234 can compute a difference value between the counter value and the control value 228. The validation engine 234 can compare the difference value to a threshold value. The threshold value can represent a minimum amount of time for regeneration of the key. For example, the threshold value can be set to require a minimum of 5 seconds between generation of the key and the subsequent expiration time associated with the key.

If the validation engine 234 determines that the appropriate conditions are not satisfied, the validation engine 234 can send a signal or message (e.g., a flag, an error, an exception, etc.) indicating the issue. For example, if the expiration time occurs before the key is generated, the validation engine 234 can inform the application 212 that the key will not have a future expiration enforced, or that the key is not the version of the key that the input values request. In a similar manner, if the expiration time will occur in less than a minimum amount of time from the generation of the key, the validation engine 234 may similarly indicate this to the application 212. In some implementations, the validation engine 234 may block output of the generated key if the conditions checked by the validation engine 234 are not satisfied. In the case of generating an original key, for which the enforcement of a time limit of a future expiration time is desired, blocking output of the key may be useful to avoid the application 212 receiving a key for which no time limit is being applied. If the request from the application 212 or mode of operation of the security module 108 is such that applying a future time constraint is needed, the security module 108 can indicate to the application 212 that a different control value indicating a later expiration time is needed.

As discussed above, the security module 108 relies on a clock signal with a consistent frequency to gauge the passage of time, through the regular changes to the value in the clock counter 216. If the clock signal is slowed or stopped, or if the clock counter overflows, then the enforcement of the time conditions on key generation could potentially be circumvented. To protect against this, the clock monitoring module 218 and the overflow monitoring module 222 perform monitoring to detect conditions that interfere with enforcing time limits and trigger replacement of the stored random number 224 if those conditions occur.

The clock monitoring module 218 monitors the clock signal received by the security module to ensure that the clock frequency remains sufficiently consistent (e.g., with a predetermined tolerance). If a significant decrease in the clock frequency is detected, the clock monitoring module 218 causes all prior keys to become irretrievable by triggering the random number to provide a new random number to replace the stored random number 224. This is done because an unexpected or unmanaged change to the clock frequency would alter the security module's detection of the passage of time and so could permit to generation of keys outside the limited times set for the keys.

The overflow monitoring module 222 detects and responds to overflow of the clock counter 216. In some implementations, the clock counter 216 obtains counter values from the clock counter 216 and detects when the overflow occurs (e.g., when the value rolls over to zero after exceeding the maximum value of the counter 216). In addition or as an alternative, the overflow monitoring module 222 can obtain an overflow flag (e.g., a signal or an event notification) sent by the clock counter 216 indicating that the clock counter 216 has overflowed.

In some implementations, the overflow monitoring module 222 obtains counter values periodically. The overflow monitoring module 222 can be configured to detect an overflow of the clock counter 216 based on the obtained counter values. For example, the clock monitoring module 218 can compare counter values obtained from the clock counter 216 to an overflow value indicating a value of a counter value after an overflow of the clock counter 216 occurs. In some implementations, the clock counter 216 starts at 0 and increments until overflow starts the count at 0 again. In some implementations, the clock counter 216 starts at another value and increments or decrements until the initial value is reached again. The overflow monitoring module 222 can detect overflows by comparing one or more counter values obtained from the counter value 216 to values associated with overflows such as an initial counter value.

When the overflow monitoring module 222 detects overflow, it sends a signal to instruct the random number generator 220 to generate a new random number to replace the stored random number 224. This change makes all keys that were generated using the previous stored random number 224 unrecoverable. This is done because, after the counter 216 overflows, the comparisons of the counter values with the respective control values of previously generated keys will no longer be accurate indications of whether the time constraints are satisfied. Accordingly, resetting the value of the clock counter 216 through overflow or other means leads to resetting the key generation overall, so that time constraints are properly judged relative to the new state of the counter 216.

In some implementations, the random number generator 220 is a hardware-based random number generator (HRNG). For example, the random number generator 220 can generate a random number, such as the random number 224 as a function of one or more physical environmental attributes (e.g., temperature, electrical noise, etc.). The physical environmental attributes can include status of electrical charges within the random number generator 220. A hardware-based random number generator provides security by helping to ensure that parties are not easily able to model the state of the random number generator 220 to determine a corresponding generated random number. In some implementations, the random number generator 220 includes one or more pseudorandom number generators (PRNGs). For example, the random number generator 220 can include one or more functions configured to produce a random number that is difficult to model based solely on the generated random number output of the random number generator 220.

The example of FIG. 2A shows an implementation in which a key can be generated repeatedly using the same user context 226 and the control value 228 until the expiration time 206, or until an earlier event that changes the stored random number 224 (e.g., reset of the device 104, manipulation of the clock signal, or overflow of the clock counter 216). Before the expiration time 206 or any change to the stored random number 224, any entity can provide the user context 226 and the control value 228 to the security module 108 to generate the same key 236. After the expiration time 206, at least the comparison result 230 provided to the key input register 213 will have changed, and so the resulting key will also change. As discussed, the key derivation engine 232 can be configured such that a change in the input induces a large change in the output. A change to the comparison result 230 will mean that, even when an entity provides the same user context 226 and control value 228, the comparison result 230 will be different, meaning that the key 236 cannot be generated again. After the expiration time, the original key 236 remains usable by applications or modules that have obtained the key 236 prior to the expiration time. However, any attempt to obtain the key 236 from the security module 108 after the expiration time will be unsuccessful.

FIG. 2B is a diagram showing an example system 250 for generating a key with an expiration time. Similar to the system 200, the system 250 includes a security module 108 that generates a key 236 to be used in cryptographic operations, and the security module 108 sets an expiration time after which the key 236 can no longer be generated again. However, in generating the key 236, the security module 108 in the system 250 provides a different combination of data to the key derivation function 232 compared to what is used in FIG. 2A. The system 250 stores the key derivation context in a key input register 251 (instead of key input register 213), in which a key 252 is stored instead of the stored random number 224. To improve security, the key 252 can be based on a stored key 258 that is updated regularly and frequently, such as each minute, every five minutes, etc.

The key 252 is set and regularly updated by an iterative key engine 256, rather than being set by the random number generator 220. Because the key 252 does not rely solely on a random number generator, the system 250 can be more resilient to the random number generator being compromised. For example, in the system 250, an attacker would have to compromise (e.g., gain control of) both the random number generator 254 and the iterative key engine 256 in order to compromise the security of keys generated using the values in the key input register 251.

The security module 108 changes the value of the stored key 258 at regular intervals. Each change is made by taking the current value of the stored key 258 and running it through a key derivation function once to generate a new stored key 258, which replaces the previous value. Thus, in normal operation (e.g., without a device reset or tampering to trigger a new random number to replace the stored key 258), the current stored key 258 is derived from the one before, which itself is derived from the one before, and so on. This mechanism provides a progressive, monotonic advance through a series of stored keys 258 over time. The future value of a stored key 258 can be derived, but past values of the stored key 258 cannot since they are not stored and cannot be readily determined from the current stored key 258. Given the current value of the stored key 258, the value of the stored key 258 that will be present at a particular time in the future can be calculated by iteratively running the key derivation function an appropriate number of times.

When the security module 108 generates a key 236, the value used in the key input register 251 for the key 252 is set based on the most recent value for the stored key 258. However, the stored key 258 is not necessarily used directly as the value of the key 252. Rather, the iterative key engine 256 starts with the current value of the stored key 258 and performs a variable number of key derivation cycles to arrive at the value used for the key 252. When performing multiple key derivation cycles, in the first key derivation cycle, the stored key 258 is the input to the key derivation process, then in each subsequent cycle the iterative key engine 256 runs the key output of the previous cycle through the key derivation function again. The same key derivation function is used for each key derivation cycle, making it possible to repeatedly generate the same final result if using the same starting input and if same number of key derivation cycles are performed. The number of key derivation cycles to perform in order to generate the key 252 is determined based on the control value 228, which specifies the expiration time for generation of the key 236. When the security module 108 generates the key 236, the iterative key engine 256 sets the key 252 to the value of the stored key 258 that will be present at the expiration time. This way, at any point in time up to the expiration time set by the control value 228, the iterative key engine 256 can recreate the same stored key 258 that will be present at the expiration time, and so properly generate the key 236.

In further detail, the iterative key engine 256 accesses a stored key 258. The stored key 258 is initially set to a random number generated by the random number generator 254. The stored key 258 is replace with a random number upon device reset, detection of tampering (e.g., variation in the clock signal), or a full overflow of the counter value 204. The iterative key engine 256 updates the stored key 258 periodically, for example, in response to detecting overflow of a portion of the clock counter value 204. Rather than wait for the entire counter value to fully overflow (e.g., a roll-over of the most significant bit, or of a return to zero of all 32 bits if a 32-bit counter value is used), the iterative key engine 256 can update the stored key 258 much more frequently in response to detecting overflow of only a portion of the counter value 204 (e.g., a change in an intermediate bit, such as a return to zero the 7 least-significant bits of the 32 bits of the clock counter value 204). The bit or bits to monitor for change or overflow can be chosen to trigger updating of the stored key 258 at a desired interval (e.g., every 30 seconds, 1 minute, 5 minutes, etc.).

To generate the key 236 in response to a request, the iterative key engine 256 sets the value of key 252 based on the stored key 258, the clock counter value 204, and the control value 228. The iterative key engine 256 iteratively applies a key derivation function to the stored key 258 to generate the key 252. For example, the iterative key engine 256 can compare the clock counter value 204 with the control value 228 to determine the number of partial overflows (e.g., overflows of a predetermined least-significant portion of the counter value 204) that will occur from the time corresponding to the current clock counter value 204 to the time corresponding to the control value 228.

For each partial overflow (e.g., overflow of the least-significant portion), the iterative key engine 256 can perform an iteration of applying a key derivation function. The key derivation function can be a hash function or other function that deterministically maps an input value to an output value. An iteration of applying a key derivation function can include obtaining an input value and applying a key derivation function to the input value to generate an output. The first iteration can use the stored key 258 as the input value. Subsequent iterations can use the output of the previous iteration as the input. After the iterative key engine 256 performs the number of iterations corresponding to the determined number of overflows that will occur from the time corresponding to the clock counter value 204 to the time corresponding to the control value 228, the output of the last iteration is used as the key 252.

In an example scenario, consider an implementation in which the stored key 258 is updated once each minute. Each update increments the version of the stored key 258, e.g., version 0 initially, version 1 after one update cycle, version 2 after two update cycles, etc. The application 212 provides the user context 226 and the control value 228 in a first request for the key 236 at a first time, e.g., 1:10 pm. The control value 228 for the key 236 specifies a time 10 minutes in the future, e.g., 1:20 pm, after which the stored key 258 will have been updated ten times through the regular, minute-by-minute updates. At the first time, the clock counter value 204 is a first clock value, and the iterative key engine 256 determines that 10 overflows will occur from the first time (e.g., 1:10 pm) to the expiration time corresponding to the control value 228 (e.g., 1:20 pm) based on the difference between the first clock counter value and the control value 228. The iterative key engine 256 then generates the key 252 by performing 10 key derivation cycles, with second and subsequent cycles each acting on the output of the previous cycle as described above. To generate the original and authentic key 236, the key 252 (e.g., key version 10) is the result of iteratively applying the key derivation function 10 times to the value of the stored key 258 (e.g., version 0) that is present at the first time (e.g., 1:10 pm).

At a second time, such as 1:12 pm, the application 212, or another application, can provide the user context 226 and the control value 228 in a second request for the key 236. Between the first time and the second time, a determined number of bits representing the clock counter value 204 has overflowed twice. In response to each overflow, the iterative key engine 256 has updated the stored key 258 by performing the key derivation function to the stored key 258 and then replacing the previous stored key 258 with the output of the key derivation function. At the second time, the stored key 258 has been updated since the original key request, resulting in key version 2 as the value of the stored key 258. Despite the security module 108 not storing any state information about the original key, the iterative key engine 258 can still determine the correct value for key 252 based on the difference between the current time and the expiration time (e.g., from the clock counter value 204 and the control value 228).

At the second time (e.g., 1:12 pm), the clock counter value 204 has increased to a second clock value, and the stored key 258 at the time is version 2. The iterative key engine 256 determines that 8 overflows will occur from the second time to the time specified by the control value 228 based on the difference between the second clock value and the control value 228. The iterative key engine 256 then generates the key 252 by performing 8 key derivation cycles on the stored key 258 (e.g., version 2). The current stored key 258 (e.g., version 2) has the effect of two key derivation cycles already incorporated into it. Applying 8 further key derivation cycles to the version 2 key will reach the same result (e.g., version 10) that was achieved by applying 10 key derivation cycles to the version 0 key. As a result, the key 252 generated at the second time is the same value for the key 252 that was generated at the first time. With the same key 252 used, as long as the other contents of the key input register 251 (e.g., the user context 226, the control value 228, and the comparison result 230) are the same as used when responding to the first request, the system 250 will generate the same key 236 at the second time (e.g., 1:12 pm) that was generated at the first time (e.g., 1:10 pm). In this way, the key, such as the key 236, can be used in cryptographic operations and its derivation can be time limited in the same way as discussed for the system 200.

Still continuing the example, a third request for the same key 236 may be received after the expiration time, such as at 1:21 pm. At this time, the stored key 258 has already been updated past the value used as key 252 to generate the original key 236 in response to the first and second requests. For example, at 1:21 pm the value of stored key 238 would be version 11, where the previous version 10 was used to generate the authentic, original key 236. Because the stored key 258 is progressively updated over time with no storage of prior versions, it is not possible to obtain prior versions of the stored key 258. As a result, in this example, within one minute after the expiration time set by the control value 228, the original key 236 becomes unrecoverable due to the unavailability of the proper value of key 252 (e.g., version 10), which is needed to generate the original key 236. This mechanism further strengthens the enforcement of the expiration time, in addition to the change in the comparison result 230, which also changes in value once the expiration time is reached.

In the example of FIG. 2B, the control value engine 210, the application 212, the comparator 214, the clock counter 216, the clock monitoring module 218, the key derivation engine 232, and the validation engine 234, operate as described in FIG. 2A. The random number generator 254 can be identical to the random number generator 220, except that the random number generator 254 sets the stored key 258 instead of the random number generator 220 setting the random number 224. Similarly, the overflow monitoring module 255 can perform the functions described for the overflow monitoring module 222, except that the overflow monitoring module 255 additionally determines a second type of overflows, e.g., partial overflows representing overflow of a least-significant subset of bits in the counter value 204, as discussed below.

FIG. 2C shows operations of the iterative key engine 256 of the example system 250 in more detail. As discussed, the iterative key engine 256 updates the stored key 258 and sets the key 250 in the key input register 251. The iterative key engine 256 includes a key derivation engine 260. The key derivation engine 260 applies a key derivation function to an input value to generate an output value.

In the case where the iterative key engine 256 updates the stored key 258, the key iterative key engine obtains input from the overflow monitoring module 255. The overflow monitoring module 255 can detect and respond to different types of overflows of the clock counter 216, which can trigger different actions in the security module 108.

A first type of overflow can be a full overflow of the clock counter value 204, e.g., with all bits rolling over to zero after exceeding the maximum value of the counter 216. This can be detected as the change from “1” to “0” of the most-significant bit, when the counter is monotonically incremented. The overflow monitoring module 255 can generate and send a signal to the random number generator 254 in response to the first type of overflow as discussed for the overflow monitoring module 222 of the system 200. The security module 108 can be configured to respond to this signal by causing the random number generator 254 to generate a random number and set the generated random number as the new stored key 258, replacing the previous value of the stored key 258.

A second type of overflow can be a partial overflow, where only a subset of the bits in the clock counter value overflow. A predetermined portion of the clock counter value can be monitored for overflow, to represent overflow of a least significant set of bits in the clock counter value 204. For example, if the clock counter value 204 is a 32-bit value, this second type of overflow may be the overflow of a predetermined number of bits in the least-significant portion (e.g., the least significant 10 bits, 8 bits, or any appropriate number chosen in advance). This can be detected as a change of an intermediate bit (e.g., a change from “1” to “0” of the 11^{th} bit) or all zeros in a set of bits (e.g., bits 1 through 10). In general, the second type of overflow (e.g., partial or intermediate overflow) can occur multiple times between overflows of the first type (e.g., overflow of the most significant bit).

In response to the overflow monitoring module 255 detecting the second type of overflow (e.g., by monitoring the clock counter 216), the overflow monitoring module 255 can generate and send a signal to the key derivation engine 260. The key derivation engine 260 can be configured to respond to this signal by obtaining the current stored key 258, applying a key derivation function to the stored key 258 to generate a temporary key 262, and replacing the stored key 258 with the newly-generated temporary key 262.

The iterative key engine 256 is also used to set the key 252 of the key input register 251. In this case, the iterative key engine 256 obtains the control value 228 and the current clock counter value 204. A cycle count engine 264 determines a number of second-type overflows (e.g., overflows in the least significant portion) that will occur between the time represented by the current clock counter value 204 and the time represented by the control value 228. This number of second-type overflows is then set as the number of key derivation cycles to perform in order to generate the key 252. In some implementations, determining the number of second-type overflows includes determining a difference between the control value 228 and the clock counter value 204. For example, the clock counter value 204 can be represented using 16 bits, and a second-type overflow includes the least significant 10 bits rolling over to 0. The cycle count engine 264 can determine the difference between the most significant 6 bits of the control value 228 and the most significant 6 bits of the clock counter value 204. The difference between the values of the most signification portions (e.g., the amount by which the control value 228 exceeds the current clock counter value 204, when ignoring the least-significant portion) can be set as the key cycle count 266, which sets the number of key derivation cycles to be performed. The key cycle count 266 represents the number of second type overflows that would occur up to the time set by the control value 228 and is a parameter that controls the number of iterations of applying the key derivation function to be performed to generate the key 252 for the input register 251.

In the example of FIG. 2C, the key cycle count 266 is a value controlling the number of times to iterate through applying a key derivation function of the key derivation engine 260. As an example, the cycle iteration engine 264 can determine that four, second-type overflows will occur between a time corresponding to the clock counter value 204 and a time corresponding to the control value 228. The iterative key engine 256 can generate the key 250 as the output of applying a key derivation function four times. In the first of the four iterations, the key derivation engine 260 obtains the current stored key 258 and applies a key derivation function to generate a temporary key 262a as output. The key derivation engine 260 then performs the remaining iterations, each time using the temporary key 262a generated in the previous iteration as an input to the key derivation function to generated a new temporary key 262a as output. The process of using the output of the key derivation function as the input to the key derivation function continues for a number of iterations specified by the key cycle count 266. The key derivation engine 260 provides the output from the last iteration as the key 252 for the key input register 251.

Variations to the operation iterative key engine 256 can be made. For example, rather than update the stored key 258 for every second-type overflow, the iterative key engine 256 can update the stored key 258 every other second-type overflow. To accommodate this, the cycle iteration engine 264 can determine the key cycle count 266 as half of the determined second-type overflows that would occur in the time period between the clock counter value 204 and the control value 228. Other functions and update schedules can be used to update the stored key 258 based on overflows of bits representing the clock counter value 204 and to determine the key cycle count 266 as appropriate.

The key derivation engine 260 can include a hash function that maps an input value to an output value. In some implementations, the key derivation engine 260 uses the same key derivation function as the key derivation engine 232 or may even be the key derivation engine 232 itself.

FIG. 3 is a diagram showing an example of a system 300 for time-limited key generation. In this example, the security module 108 has a different configuration to be able to support operation in multiple modes. In one mode, a generated key can be generated again as many times as desired until an expiration time in the manner discussed above for FIG. 2A. In a second mode, a “time vault” mode, a generated key is provided once and then cannot be generated again until an access time. After the initial generation of a key, the key is figuratively kept locked in the vault and is only able to be obtained again from security module 108 after the access time. The example of FIG. 3 shows the security module 108 being used in the time vault mode.

The security module 108 includes many of the components shown in FIG. 2A, for example, the clock monitoring module 218, the random number generator 220, the overflow monitoring module 222, the comparator 214, and the clock counter 216. The implementation shown in FIG. 3, the security module 108 additionally includes an AND operator 308, a multiplexer 310, and a vault counter 312. The security module 108 includes a key input register 314 configured to store more values than the key input register 213 of FIG. 2A. The system 300 includes the control value engine 210 that assists to generate control values and the application 212 that generates and provides input for the security module 108 to generate a key 320.

In the example of FIG. 3, the key derivation context stored in the key input register includes a random number 224, a user context 226, a control value 315, a status mask 317, an operation result 318, and a vault context 316. Of these items, the user context 226, the control value 315, and the status mask 317 are provided by the application 212 requesting the key. The random number 224 is a secret, stored random number that is generated by the random number generator 220. As discussed above, the random number 224 persists and is reused across multiple keys unless one of certain conditions occur to trigger the random number 224 to be replaced with a new random number. The operation result 318 and the vault context 316 are determined by the security module 108 and are discussed further below. In the case of the vault context, the application 212 provides an input vault context that the security module 108 uses under certain conditions.

When the application 212 requests a key, the application 212 can select from among the multiple modes of operation of the security module. For example, the application 212 sets the value of the status mask 317 (also referred to as “SM”) to indicate whether to apply an expiration time for generating a key (e.g., setting the latest time the key can be generated) or to apply a “time vault” restriction (e.g., setting the earliest time the key can be generated). As a result, the status mask 317 has the effect of selecting the type of time restriction that will be enforced for the key. A status mask 317 value of “0” selects a time vault restriction, and a status mask 317 value of “1” selects an expiration condition for generation of the key. The status mask 317 itself is a value used in the key derivation function context, and so different values of the status mask 317 will result in different keys being generated. Also, because the mode selection and time restrictions are a result of the key generation process, the security module 108 does not need to evaluate the status mask 317 and perform other operations to select or switch modes. Instead, simply carrying out the key generation with the logic shown has the effect of enforcing the appropriate type of restriction, as discussed below.

To determine the control value 315 to provide to the security module 108, the application 212 can interact with the control value engine 210 to obtain a control value 315 that specifies a future time. As with the example of FIG. 2A, the control value 315 can be a timestamp or value indicating a time. However, the type of time restriction that is applied using this time varies depending on the mode selected by the status mask 317. If the status mask 317 is set to “1,” the control value 315 will set an expiration time for generation of the key. If the status mask 317 is set to “0,” the control value 315 represents the time at which further generation of the key becomes available.

The application 212 can provide, to the control value engine 210, data indicating a time, e.g., an access time 304 at which further generation of the key should be allowed. The control value engine 210 uses the access time 304, along with the clock frequency 208 and a clock counter value 204 (indicating the current value of the clock counter 216) to generate the control value 315 that represents the access time 304. As discussed for FIG. 2A, the control value 315 can encode or specify the desired time as a future value of the clock counter 216 that will occur at the desired time. Similar to the generation of the control value 228 in FIG. 2A, the control value engine 210 can compute a difference between a current time and the access time 304. The control value engine 210 can compute a number of increments of the clock counter 216 that will occur from the current time to the access time 304. The control value engine 210 can add the computed number of increments to the clock counter value 204 to generate the control value 315 that indicates the access time 304. The same technique for specifying a time in a control value can be used for either the expiration mode or time vault mode, but the security module 108 can apply a different time restriction based on the specified time depending on the mode selected with the status mask 317.

The application 212 can provide the user context 226 as described in reference to FIG. 2A. In other words, the user context 226 can be a key identifier that identifies the key or its purpose and can be any value within predetermined size constraints.

The application 212 can also provide an input vault context 307 value. The input vault context 307 value is not used in the initial generation of the key 320, but an appropriate value is needed to re-create the key 320 in the future. In effect, the input vault context 307 is a value needed to unlock the vault to allow a previously-generated key to be generated again. As discussed further below, to re-generate a previously generated key: (1) the time constraint must be satisfied to enable the input vault context 307 to be passed into the key input register 314, and (2) the value of the input vault context 307 must match the vault context value used to previously generate the key.

When the security module 108 receives the request for a key from the application 212, the security module 108 provides the user context 226, the control value 315, and the status mask 317 directly to the key input register 314. The random number 224 in the key input register 314 is a previously generated and stored random number as discussed above. The security module 108 then generates the remaining two values for the key input register 314, the operation result 318 and the vault context 316. The operation result 318 is used to enforce the time constraint for the expiration mode, and the vault context 316 is used to enforce the time constraint for the time vault mode. The values of both the operation result 318 and the vault context 316 can be affected by a comparison result CMP that indicates whether the current counter value of the clock counter 216 is greater than the received control value 315.

The security module 108 determines the operation result 318 by first generating the comparison result CMP (e.g., illustrated as the comparison result 230 in FIG. 2A). The security module 108 provides the control value 315 to the comparator 214 and, as discussed in reference to FIG. 2A, the comparator 214 compares the control value 315 with a current value of the clock counter 216.

Instead of including the comparison result CMP in the key input register 314, the security module 108 uses an AND operator 308 to selectively pass the comparison result CMP or the status mask 317 depending on the mode selected by the status mask 317.

If the status mask 317 has a value of “1,” then the expiration mode is selected and the result of applying the AND operator 308 to the status mask 317 and comparison result CMP will be the comparison result CMP itself. This allows the time limit discussed with respect to FIG. 2A. In the expiration mode, the operation result 318 is the comparison result CMP, and the key is initially generated with a comparison result CMP of “0” while the counter value of the clock counter 216 is less than the control value 315. After the expiration time, the comparison result CMP changes to “1” (e.g., because the counter value is greater than the control value 315), and so the resulting key will no longer match the original key, making the original key unrecoverable after the expiration time.

On the other hand, if the status mask 317 has a value of “0,” the time vault mode is selected, and the operation result 318 will always be “0.” Regardless of the comparison result CMP, the result of applying the AND operator 308 to the comparison result CMP and the zero-valued status mask 317 will be zero. This aspect of the security module 108 maintains the operation result 318 consistent for the time vault mode so the vault context 316, not the operation result 318 enforces the time constraint.

The security module 108 generates the vault context 316 using the multiplexer 310 and the vault counter 312. The security module 108 is configured so that in expiration mode, the vault context is consistently the same value, e.g., a value of zero for each of the bits of the vault context 316. For the time vault mode, the vault context 316 varies, having a value selected from among the value of the vault counter 312 and the input vault context 307.

The multiplexer 310 in the illustrated example has four inputs, two select lines, and one output. The inputs and the output are wide enough for multi-bit values, such as each supporting values of 8-bit, 16-bit, 32-bit, etc. The bit width of the inputs and outputs can be the same as the bit width of the maximum value of the vault counter 312. The two select lines each receive single-bit values, in this case, respectively (1) the comparison result CMP from the comparator 214 and (2) the status mask SM that selects the mode of key generation to be used. When the status mask SM has a value of “1” (expiration mode), the multiplexer 310 selects zero as the output to provide as the vault context 316, regardless of the value of the comparison result CMP. When the status mask SM has a value of “0” (time vault mode), the multiplexer 310 selects from between the input vault context 307 and the value of the vault counter 312.

The vault counter 312 provides a monotonically changing value (e.g., solely incrementing) that changes each time a value is read from the vault counter 312. The vault counter 312 can be configured to be initialized at zero and have the counter value incremented upon each read of the counter value. For example, the security module 108 can read the vault counter 312 to provide the vault counter value to the multiplexer 310. The vault counter 312 increments the counter value after each read. For example, if the vault counter 312 initially had a value of zero, a value of zero would be provided for generating a first key. For the next key request, the vault counter value would be one, having been incremented due to the process of reading the vault counter 312 in generating the earlier key.

The multiplexer 310 is arranged to select the vault counter value as output when the status mask SM is “0” (e.g., time vault mode selected) and when the comparison result is “0” (e.g., the access time has not yet been reached, so the vault remains locked). On the first generation of a particular key, while the access time has not yet been reached, the key is generated with the vault context 316 being whatever value was obtained from the vault counter 312. The act of reading the value counter 312 changes the state of the vault counter 312 by incrementing the stored value. As a result, a subsequent request for the same key before the access time would generate a key that uses the incremented value counter value, not the one used previously, and so would not generate the original key. As long as the current time is still before the access time (e.g., the comparison result CMP is “0” indicating the clock counter value is less than the control value 315), the current vault counter value will be used for the vault context 312 and that value will be different from the one needed to obtain the original key. As a result, all parties are locked out from generating a previous key before the access time for the key.

Once the access time is reached for a particular key, the vault counter value is no longer provided as the vault context 316. When the comparison result CMP is “1,” the multiplexer 310 selects the input vault context 307 from the application 212 to be the vault context 316 instead of selecting the vault counter value from the vault counter 312. If the application 212 provides the correct input vault context 307 value (e.g., the vault context value used in generating the original key), then the application can have the security module 108 once again create the original key. This operation effectively unlocks the vault and enables generation of a previous key after the access time is reached.

Once the values in the key input register 314 are set, the security module provides the full set of values as input to the key derivation engine 232. As discussed in reference to FIG. 2A, the key derivation engine 232 applies a key derivation function to the contents of the key input register 314 to generate a key, in this case the key 320. The key 320 can be represented by one or more alphanumeric symbols, bits, or another appropriate representation. The security module 108 provides the output 324 including the key 320 to an entity or process, such as the application 212 that requested the key.

To facilitate future generation of a key, the security module 108 can provide the vault context 316 used to generate a key as an output. For example, when generating the key 320, the security module 108 can also provide the value of the vault context 316 that was used in generating the key 320. In order to re-generate a key that was generated in the time vault mode, the vault context 316 for that key needs to be known and provided to the security module 108 with the request for the key. The security module 108 provides the value of the vault context 316 to the application 212 so it can forward it on to another application or module or so the application 212 can again re-generate the key 320 if needed. Overall, for another application or module to also generate the key 320, the other application or module will need to provide the user context 226, the control value 315, the status mask 317 value, and the vault context 316 for the key 320.

If subsequent generation of the key 320 is requested before the access time 304, the values in the key input register 314 will include a vault context 316 that does not match the vault context 316 present when the key 320 was originally generated. Even if the correct vault context 316 is provided as an input vault context 307, the multiplexer 310 will select for the vault counter value from the vault counter 312 to be used as the vault context 316 instead of any input vault context 307 that is provided with the request. As a result, the key that is generated will not match the key 320, and the key 320 will not be able to be generated again until the access time 304 specified by the control value 315.

In the time vault mode, the security module 108 relies on the vault counter 312 increasing its state consistently so that previous counter values are not repeated. As a result, the security module 108 can be configured to trigger replacement of the random number 224 with a newly-generated random number from the random number generator 220 when the vault counter is re-initialized or experiences overflow. For example, the overflow monitoring module 222 can be configured to monitor overflow in the vault counter 312 as well as the clock counter 216, and can be configured to replace the stored random number 224 with a new random number in response to either counter experiencing overflow or improper manipulation.

In some implementations, the output 324 of the vault context 316 can be used to determine if a key was generated as intended. For example, when re-generating a previous key, a user, entity, or process, such as the application 212, can obtain the vault context 316 from the output 324 and compare with a known vault context 316 for the desired key. If the output vault context does not match the known vault context for the key 320, then the key requester can determine that the access conditions have not been met and the received key is not the desired key 320. The application 212 can then decide, based on comparing the provided vault context to the vault context 316 whether or not to use the key for cryptographic operations, such as encryption or decryption of data.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A method comprising:
receiving a request that provides a key identifier;
obtaining a control value indicating a future time;
obtaining a counter value indicating a first time, wherein the counter value is based on a current state of a counter, wherein the counter is configured to update the state of the counter at a predetermined frequency;
generating a comparison result based on comparing the control value indicating the future time with the counter value indicating the first time;
generating a key based on the key identifier, the control value, the comparison result, and a stored random number; and
providing the key in response to the request.

2.-5. (canceled)

6. The method of claim 1, comprising:
detecting at least one of the following:
a manipulation of the counter; or
an overflow of the counter; and
in response to detecting the manipulation of the counter or the overflow of the counter, replacing the stored random number with a new random number obtained from a hardware-based random number generator.

7. (canceled)

8. The method of claim 1, wherein:
the predetermined frequency is based on a frequency of a clock signal; and
the method comprises:
detecting a change in the frequency of the clock signal; and
in response to detecting the change in the frequency of the clock signal, replacing the stored random number with a new random number obtained from a hardware-based random number generator.

9. The method of claim 1, comprising, after generating the key, and before providing the key in response to the request:
obtaining a second counter value from the counter based on a state of the counter after the key is generated; and
determining that the second counter value satisfies a predetermined condition specifying a relationship with respect to the control value,
wherein providing the key in response to the request is performed in response to determining that the second counter value satisfies the predetermined condition.

10. The method of claim 9, wherein determining that the second counter value satisfies the predetermined condition comprises determining that the second counter value represents a time that is before the future time represented by the control value.

11. The method of claim 1, wherein:
the control value is a future counter value representing a value that the counter will reach at the future time; or
the control value specifies a counter value that, when reached by the counter, disallows further generation of the key based on the key identifier and the control value.

12-14. (canceled)

15. The method of claim 1, wherein:
the key is a first key;
the comparison result is a first comparison result;
the method further comprises, after generating the first key:
receiving a second request associated with the key identifier and the control value;
obtaining a second counter value based on a state of the counter, the second counter value indicating a second time that is after the first time and before the future time indicated by the control value;
generating a second comparison result based on comparing the control value indicating the future time with the second counter value indicating the second time; and
generating a second key based on the key identifier, the control value, the second comparison result, and the stored random number; and the second key is:
the same as the first key based on the second comparison result being the same as the first comparison result; or
different from the first key based on the second comparison result being different from the first comparison result.

16. (canceled)

17. The method of claim 1, wherein obtaining the control value comprises:
receiving a time value indicating the future time or an amount of time until the future time is reached; and
determining, as the control value, a future counter value that will be reached at the future time, the future counter value being determined based on a current counter value from the counter, the time value, and the predetermined frequency.

18. (canceled)

19. The method of claim 1, further comprising:
determining a vault context value based on the comparison result, wherein the comparison result is used to select the vault context value from among a vault counter value and an input vault context value; and
wherein generating the key involves applying a key derivation function to a set of values comprising the key identifier, the control value, the comparison result, the stored random number, and the vault context value.

20. (canceled)

21. The method of claim 1, comprising:
obtaining a mode selection value configured to select from among multiple modes for generating keys, the multiple modes comprising (i) a first mode that disallows further generation of the key after the future time and (ii) a second mode that disallows further generation of the key before the future time,
wherein generating the key comprises applying a key derivation function to a set of values comprising the key identifier, the control value, the comparison result, the stored random number, and the mode selection value.

22. A hardware module for generating cryptographic keys, the hardware module comprising:
an input interface configured to receive (i) a control value representing a time and (ii) a key identifier;
a random number generator configured to generate a random number;
a memory element that is configured to store the random number;
a counter configured to change monotonically based on a clock signal;
a comparator configured to generate a comparison result based on a comparison of the control value with a counter value from the counter; and
key derivation circuitry configured to generate a key based on the key identifier, the control value, the comparison result, and the random number stored in the memory element.

23. The hardware module of claim 22, wherein the hardware module is configured to:
generate the key again in response to receiving the control value and the key identifier; and
disallow generation of the key after the time represented by the control value.

24. The hardware module of claim 22, wherein:
the hardware module is configured to limit a time period in which the key can be generated again; and
the control value represents a future counter value that sets a future time at which the time period expires or a future time at which the time period begins.

25. (canceled)

26. The hardware module of claim 22, wherein the hardware module is configured to:
determine whether the counter value from the counter has a predetermined relationship with respect to the control value; and
output the key based on the counter value from the counter having the predetermined relationship with respect to the control value.

27. The hardware module of claim 22, wherein the hardware module is configured to:
determine a second counter value based on a state of the counter after the key is generated; and
selectively:
output the key based on the second counter value having a predetermined relationship with respect to the control value; or
block output of the key based on the second counter value not having the predetermined relationship with respect to the control value.

28.-30. (canceled)

31. The hardware module of claim 22, wherein the hardware module is configured to generate multiple different keys and enforce separately-specified expiration times for the ability to re-generate the respective keys, without storing the keys and without storing the expiration times.

32. The hardware module of claim 22, wherein:
the input interface is configured to receive an input context value;
the hardware module is configured to determine a context value based on the comparison result, wherein the comparison result is used to select the context value from among (i) a counter value from a second counter and (i) the input context value; and
the key derivation circuitry is configured to apply a key derivation function to a set of values comprising the key identifier, the control value, the comparison result, the stored random number, and the determined context value.

33. (canceled)

34. The hardware module of claim 22, wherein:
the input interface is configured to receive a mode selection value that identifies a mode select from among multiple modes for generating keys, the multiple modes comprising (i) a first mode that disallows further generation of the key after a future time and (ii) a second mode that disallows further generation of the key before the future time; and
the key derivation circuitry is configured to apply the key derivation function to a set of values comprising the key identifier, the control value, the comparison result, the stored random number, and the mode selection value.

35. (canceled)

36. (canceled)

37. The hardware module of claim 34, further comprising a multiplexer configured to select from among multiple input values to provide a context value to the key derivation circuitry, wherein:
the multiple input values comprise a predetermined value, an input context value, and a counter value from a second counter;
the multiplexer is configured to select the context value from among the multiple input values based on the mode selection value and the comparison result; and
the context value selected by the multiplexer is included in the set of values to which the key derivation circuitry applies the key derivation function to generate the key.

38. The hardware module of claim 22, comprising a second counter that is configured to alter its stored value in response to the generated key being read from the hardware module,
wherein the hardware module is configured to use counter values from the second counter in generation of keys such that, after the generated key is read from the hardware module, the hardware module blocks further generation of the key until the time represented by the control value is reached.
